(19) United States
(12) Patent Application Publication
(10) Pub. No.: US 2025/0385817 A1
(43) Pub. Date: Dec. 18, 2025

(54) SYSTEMS AND METHODS FOR ESTIMATING OFFSET OF SYNCHRONOUS SCRAMBLERS

(71) Applicant: SkySafe, Inc., San Diego, CA (US)

(72) Inventor: Chun Kin Au Yeung, San Diego, CA (US)

(21) Appl. No.: 19/188,557

(22) Filed: Apr. 24, 2025

Related U.S. Application Data
(60) Provisional application No. 63/659,825, filed on Jun. 13, 2024.

(51) Int. Cl. H04L 25/03; H03M 13/09; H04L 1/00

(52) U.S. Cl. CPC H04L 25/03866; H03M 13/09; H04L 1/0057

(57) ABSTRACT

Systems and methos for estimating offset of synchronous scramblers are provided. In one aspect, a method of estimating an initial state of a synchronous scrambler in the presence of a linear error control code includes receiving a vector including a transmit bit vector encoded using the linear error control code, and performing nulling on the linear error control code to null impact of the linear error control code from the received vector. The method also includes obtaining a system of equations from the received vector in response to performing the nulling on the linear error control code, and using a min-sum procedure to recover the initial state of the synchronous scrambler from the system of equations.

### CROSS-REFERENCE TO RELATED APPLICATION(S)

This application claims the benefit of U.S. Provisional Application No. 63/659,825, filed Jun. 13, 2024, which is hereby incorporated by reference in its entirety.

### BACKGROUND

### Technological Field

The systems and methods disclosed herein are directed to estimating offset of synchronous scramblers, and in particular, estimating an initial state of a synchronous scrambler in the presence of a linear error control code.

### Description of the Related Technology

Unmanned Aircraft Systems (UAS), more commonly known as drones, are used extensively in a large number of exciting and creative applications, ranging from aerial photography, agriculture, product delivery, infrastructure inspection, aerial light shows, and hobbyist drone racing. Despite the usefulness of drones in many applications they also pose increasing security, safety, and privacy concerns. Drones are being used to smuggle weapons and drugs across borders. The use of drones near airports presents safety concerns, which may require airports to shut down until the surrounding airspace is secured. Drones are also used as a tool of corporate and state espionage activities. Thus, there is demand for an effective Counter-Unmanned Aircraft System (CUAS) solution to detect and monitor drones and mitigate the threat of drones when necessary.

### SUMMARY

The systems, methods and devices of this disclosure each have several innovative aspects, no single one of which is solely responsible for the desirable attributes disclosed herein.

A system and method for estimating an initial state of a synchronous scrambler in the presence of a linear error control code are described. In one embodiment, the method comprises: receiving a vector including a transmit bit vector encoded using the linear error control code; performing nulling on the linear error control code to null impact of the linear error control code from the received vector; obtaining a system of equations from the received vector in response to performing the nulling on the linear error control code; and using a min-sum procedure to recover the initial state of the synchronous scrambler from the system of equations.

In some embodiments, performing nulling on the linear error control code comprises: obtaining a null space matrix of an error code control matrix by appending an identity matrix below the error code control matrix and carrying out a column reduced echelon form; and nulling the error control code using a matrix multiplication operation.

In some embodiments, the matrix multiplication operation is defined as follows:

$$A ⊗ B {=}^{△} C ,$$

$$I ( A , r ) = \{ k : A [ r , k ] = 1 \} ,$$

$$C [ {k}_{1} , {k}_{2} ] = {⊕}_{l ϵ I ( A , {k}_{1} )} B [ l , {k}_{2} ] ,$$

where A∈{0, 1}^{l}^{₁}^{×l}^{₂}, B∈ [symbol] ^{l}^{₂}^{×l}^{₃}, C∈{0, 1}^{l}^{₁}^{×l}^{₃}.

In some embodiments, obtaining the system of equations comprises: applying the null space matrix of the error code control matrix to the transmit bit vector.

In some embodiments, the method further comprises: obtaining a log likelihood ratio (LLR) of each of a plurality of transmit bits in the transmit bit vector; and performing a binary add operation for the LLRs.

In some embodiments, performing the binary add operation for the LLRs comprises: approximating the binary add operation using a min-sum operation.

In some embodiments, the min-sum operation is defined as:

$${λ}_{u} ⊕ {λ}_{ν} \approx sgn ( {λ}_{u} ) sgn ( {λ}_{ν} ) {min}_{z = \{ u , v \}} \vert {λ}_{z} \vert ,$$

where sgn(x) is a sign function defined by:

$$sgn ( x ) = \{ \begin{matrix}1 , if x \geq 0 . \\ - 1 , if x < 0\end{matrix} .$$

In some embodiments, the method further comprises: mitigating a potential threat of a drone using the synchronous scrambler based on the initial state of the synchronous scrambler.

In some embodiments, mitigating the potential threat of the drone comprises: transmitting a jamming radio frequency (RF) signal to disrupt communication between the drone and a controller, and/or spoofing the controller by sending a command to the drone to land or otherwise leave a current location.

In another embodiment, a drone detection system comprises: a radio-frequency (RF) receiver configured to receive a vector transmitted as an RF signal using a synchronous scrambler in the presence of a linear error control code; a processor; and a computer-readable memory in communication with the processor and having stored thereon computer-executable instructions to cause the processor to: receive the vector including a transmit bit vector encoded using the linear error control code; perform nulling on the linear error control code to null impact of the linear error control code from the received vector; obtain a system of equations from the received vector in response to performing the nulling on the linear error control code; and use a min-sum procedure to recover an initial state of the synchronous scrambler from the system of equations.

In some embodiments, the processor is further caused to: obtain a null space matrix of an error code control matrix by appending an identity matrix below the error code control matrix and carrying out a column reduced echelon form; and null the error control code using a matrix multiplication operation.

In some embodiments, the matrix multiplication operation is defined as follows:

$$A ⊗ B {=}^{△} C ,$$

$$I ( A , r ) = \{ k : A [ r , k ] = 1 \} ,$$

$$C [ {k}_{1} , {k}_{2} ] = {⊕}_{l ϵ I ( A , {k}_{1} )} B [ l , {k}_{2} ] ,$$

where A∈{0, 1}^{l}^{₁}^{×l}^{₂}, B∈ [symbol] ^{l}^{₂}^{×l}^{₃}, C∈{0, 1}^{l}^{₁}^{×l}^{₃}.

In some embodiments, obtaining the system of equations comprises causing the processor to: apply the null space matrix of the error code control matrix to the transmit bit vector.

In some embodiments, the processor is further caused to: obtain a log likelihood ratio (LLR) of each of a plurality of transmit bits in the transmit bit vector; and perform a binary add operation for the LLRs.

In some embodiments, to perform the binary add operation for the LLRs comprises causing the processor to: approximate the binary add operation using a min-sum operation.

In some embodiments, the min-sum operation is defined as:

$${λ}_{u} ⊕ {λ}_{ν} \approx sgn ( {λ}_{u} ) sgn ( {λ}_{ν} ) {min}_{z = \{ u , v \}} \vert {λ}_{z} \vert ,$$

where sgn(x) is a sign function defined by:

$$sgn ( x ) = \{ \begin{matrix}1 , if x \geq 0 . \\ - 1 , if x < 0\end{matrix} .$$

In some embodiments, the processor is further caused to: mitigate a potential threat of a drone using the synchronous scrambler based on the initial state of the synchronous scrambler.

In some embodiments, mitigating the potential threat of the drone comprises causing the processor to: transmit a jamming radio frequency (RF) signal to disrupt communication between the drone and a controller, and/or spoofing the controller by sending a command to the drone to land or otherwise leave a current location.

In yet another embodiment, a non-transitory computer readable storage medium has stored thereon instructions that, when executed, cause a computing device to: receive a vector including a transmit bit vector encoded a synchronous scrambler in the presence of a linear error control code; perform nulling on the linear error control code to null impact of the linear error control code from the received vector; obtain a system of equations from the received vector in response to performing the nulling on the linear error control code; and use a min-sum procedure to recover an initial state of the synchronous scrambler from the system of equations.

In some embodiments, the non-transitory computer readable storage medium further comprises: obtain a null space matrix of an error code control matrix by appending an identity matrix below the error code control matrix and carrying out a column reduced echelon form; and null the error control code using a matrix multiplication operation.

### BRIEF DESCRIPTION OF THE DRAWINGS

FIG. 1 illustrates an example environment including a drone detection system in accordance with aspects of this disclosure.

FIG. 2A illustrates an example drone detection system from FIG. 1 which can be used to detect, monitor, and/or mitigate drones in accordance with aspects of this disclosure.

FIG. 2B illustrates an example drone from FIG. 1 which can be detected with the drone detection system of FIG. 2A in accordance with aspects of this disclosure.

FIG. 2C illustrates an exemplary controller from FIG. 1 which can be used to control the drone in accordance with aspects of this disclosure.

FIG. 3 shows the decoding performance of the scrambler seed versus the underlying error control code in accordance with aspects of this disclosure.

### DETAILED DESCRIPTION

The fast growth of drone applications in industrial, commercial and consumer domains in recent years has caused great security, safety and privacy concerns. For this reason, demand has been growing for systems and techniques for drone detection, monitoring, and mitigation.

CUAS systems (or simply “drone detection systems”) may operate using multiple stages. In a first stage, the drone detection system detects the presence of a drone and determines whether the drone is a friend or a foe. The drone detection system can accomplish this by eavesdropping on the signals exchanged between the drone and an associated controller. For example, certain aspects of this disclosure may relate to soft initial offset estimation of synchronous scrambler in the presence of a linear error control code under additive white Gaussian noise (AWGN).

As part of detecting the presence of a drone, it can be desirable to estimate the initial state of a synchronous scrambler used in communications between the drone and the associated controller. Aspects of this disclosure relate to systems and techniques for estimating the initial state of a synchronous scrambler in the presence of a linear error control code under an AWGN environment. As described herein, estimating the initial state of the synchronous scrambler can include performing soft nulling on the linear error control code, turning the remaining initial scrambler state estimation problem into a soft-decoding using parity check matrix. The estimation can also involve using a min-sum procedure to recover the initial scrambler state. Simulations show that the blind seed estimation method is several dBs worse than the decoding performance of the underlying error control code. This result serves as a yardstick for further technique refinement, with the goal of achieving performance as good as the error control code.

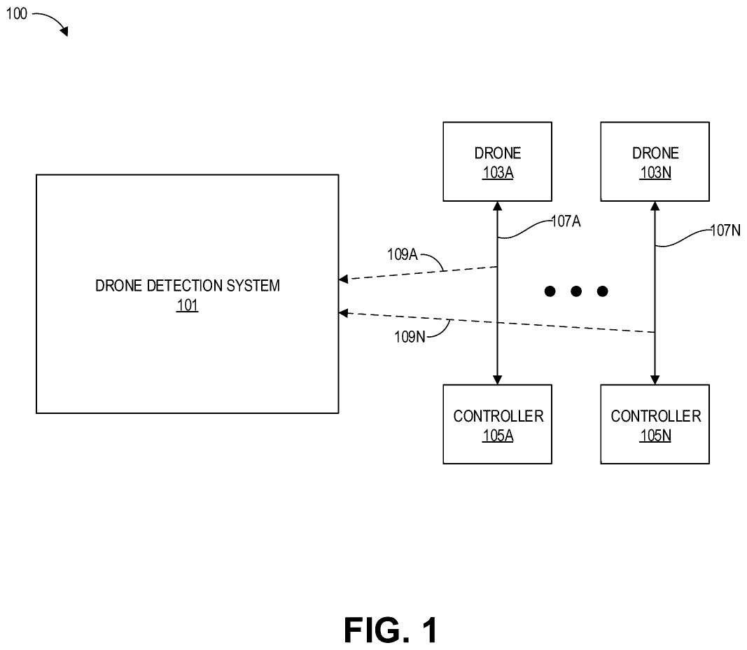

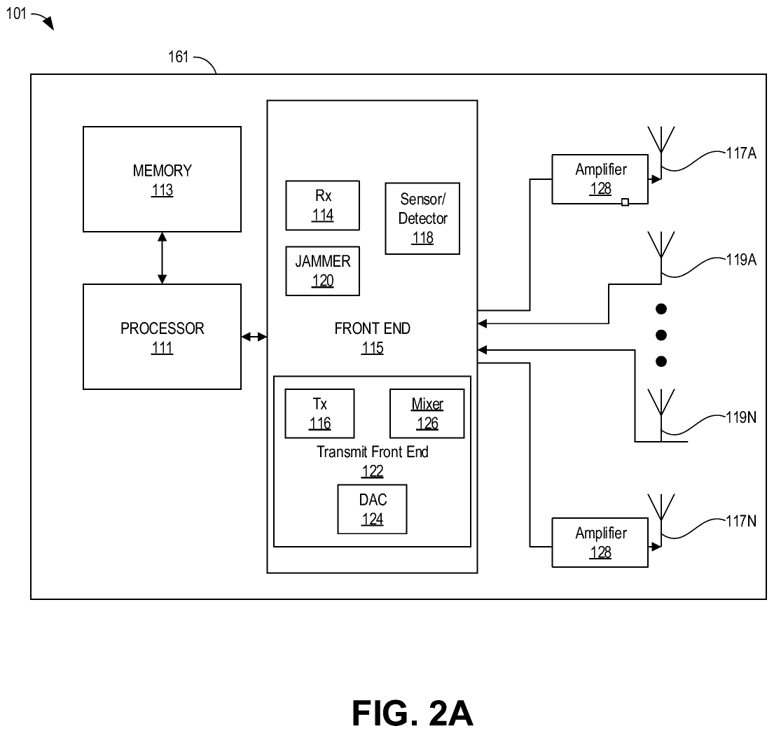

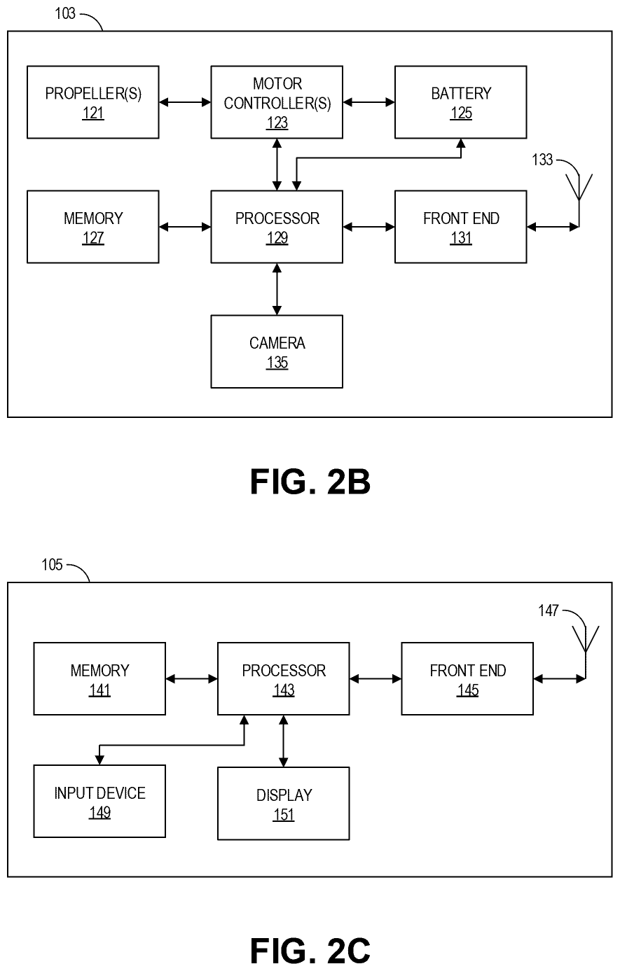

FIG. 1 illustrates an example environment 100 including a drone detection system 101 in accordance with aspects of this disclosure. In certain embodiments, the environment 100 includes the drone detection system 101, one or more drones 103A-103N, and one or more drone controllers 105A-105N (or simply “controllers”). An example of the one or more drones 103A-103N is illustrated in FIG. 2B. An example of the one or more controllers 105A-105N is illustrated in FIG. 2C.

In certain embodiments, each of the drones 103A-103N is configured to communicate to a corresponding one of the controllers 105A-105N via an RF signal 107A-107N. Although not illustrated, in some embodiments, a single one of the controllers 105A-105N may be configured to control more than one of the drones 103A-103N.

The drone detection system 101 is configured to receive eavesdrop 109A-109N on the communications between the drones 103A-103N and the controllers 105A-105N in order to detect the presence of the drones 103A-103N. For example, the drone detection system 101 may be configured to receive the RF signals 107A-107N being sent between the drones 103A-103N and the controllers 105A-105N in order to eavesdrop 109A-109N on the communication between the drones 103A-103N and the controllers 105A-105N. In certain embodiments, once the drone detection system 101 is able to decode the RF signals 107A-107N, the drone detection system 101 may monitor the drones 103A-103N and take certain actions in order to mitigate the potential threat of the drones 103A-103N. For example, the drone detection system 101 may transmit a jamming RF signal to disrupt communication between the detected drone 103A-103N and the associated controller 105A-105N, and/or spoof the controller 105A-105N by sending a command to the drone 103A-103N to land or otherwise leave the environment 100.

### I. Introduction

Many of the drones 103A-103N, also known as unmanned aerial vehicles (UAV), in the industrial, commercial, and consumer sectors utilize 3GPP Long-Term Evolution (LTE), modified LTE, or LTE-like wireless protocols for communications between drones and their control devices or associated controllers 105A-105N such as radio controllers and goggles. In the physical layer (PHY) of these LTE-based drone systems, the baseband processing at the transmitter (TX) includes a scrambler to randomize the channel coded data before modulation, which provides a certain level of security and data privacy in addition to other benefits.

A scrambling sequence is typically generated by a linear feedback shift registers (LFSR) with a scrambling seed, also called scrambling offset, to initialize the states of the LFSR. Since the receiver (RX) of the drone systems knows the seed, it can generate the same scrambling sequence to descramble the received data without the need for blind detection. However, the seed is unknown to any device outside the drone systems. Moreover, the scrambling seed is strongly tied to the identification of the drone devices. Detecting the seed assists in decoding important information and revealing the identity of a drone 103A-103N. Therefore, the scrambling seed is essential for counter-unmanned aircraft systems (CUAS) and drone detection/monitoring systems to blindly detect the scrambling seed within critical time constraints. It is a nontrivial task to blindly detect the scrambling seed in real time.

In LTE-based drones, the scrambling seed is the combination of two 31-bit Gold sequences generated by two LFSRs of length 31 with one known seed and the other unknown for blind detection. As a result, the unknown seed cannot be determined immediately in real time by any brute-force method because there are 2,147,483,648 (=2³¹) possible choices. Moreover, the seed can change regularly, which poses a strict time limit for seed detection. The blind seed detection can be further complicated by the noise and other channel impairments that may result in bit errors in the received scrambled data. The combining of multiple copies of descrambled data performed by regular RX cannot be directly applied to the noisy scrambled data in order to maximize the received signal-to-noise ratio (SNR) because the received data is randomized by scrambling.

The studies on the reconstruction of scrambler LFSR polynomials and initial states including the secret keys of stream ciphers are rich in literature. However, there are only a few solutions capable of handling errors in received bits due to channel noise. A conventional blind scrambling seed estimation scheme using the redundancy introduced by channel coding in the scrambled data may be used. This scheme requires knowledge of the coding scheme used at the TX (e.g., drone). Further, a method for reconstructing scrambler polynomials from data streams received in the presence of noise may be used. However, this method does not reconstruct scrambler seeds. It is possible to enhance the performance of the foregoing method with the reconstruction of scrambler's initial state. Nevertheless, this enhancement can require a large number of samples and knowledge of coding, which may take a long time to run especially when the degree of the polynomials is high.

It is desirable to use an efficient and fast method for blind scrambling seed estimation in a noisy channel environment that can meet strict time requirements. Thus, in this disclosure, a blind scrambling seed detection method is described that uses the soft combining of scrambled repetitive rate matched data to enhance the detection performance in a noisy channel environment. Rate matching is the mechanism specified in LTE standard to place transmitted coded data into the allocated Orthogonal Frequency-Division Multiplexing (OFDM) resources in order to achieve the required data rate.

When the transmitted data size is small (e.g., control information or small transport blocks), the interleaved codeword will be placed repeatedly in the resources. Although this repetitive structure disappears after scrambling, it is utilized in one embodiment to soft combine the received data after algebraic manipulations. If the channel coding scheme is known, similar to a blind scrambling seed estimation scheme using the redundancy introduced by channel coding in the scrambled data, the method of this embodiment uses this knowledge to remove the coding effect in the null subspace of coding to reveal the scrambling states. When the coding scheme is unknown, the method in this embodiment utilizes the repetitive structure to remove the effect of transmitted data to facilitate the seed detection. As described below, one point of novelty lies in the algebraic derivations making the soft combining of scrambled data feasible with the rate matching structure. Simulation results show that such seed detection methods with coding knowledge significantly improve the detection performance over conventional approaches. This method with no coding knowledge also compensates for the performance loss due to the lack of that knowledge. As will be further described herein, the system model for blind detection is provided. Further, the method of blind seed detection with the knowledge of encoding is described. The method of blind seed detection with no knowledge of encoding is also described.

FIG. 2A illustrates an example drone detection system 101 which can be used to detect the presence of the one or more drones 103A-103N in accordance with aspects of this disclosure. In certain embodiments, the drone detection system 101 includes a processor 111, a memory 113, a front end 115, a plurality of transmit antennae 117A-117N, and a plurality of receive antennae 119A-119N. In other embodiments, one or more of the antennae 117A-119N can be used for both transmitting and receiving signals.

In certain embodiments, the drone detection system 101 is configured to receive an RF signal (e.g., the RF signals 107A-107N of FIG. 1) via one of the receive antennae 119A-119N. The one of the receive antennae 119A-119N provides the received RF signal to the front end 115. In certain embodiments, the front end 115 can process the received RF signal into a format that can be read by the processor 111. For example, in certain embodiments, the front end 115 may perform one or more of the following actions: filtering, amplifying, analog-to-digital conversion, etc. on the received RF signal.

In certain embodiments, the memory 113 can store computer readable instructions for causing the processor 111 to detect the presence of a drone (e.g., the drones 103A-103N of FIG. 1) based on the RF signals received via the receive antennae 119A-119N. In addition, in certain embodiments, the drone detection system 101 can also be configured to provide a signal (e.g., a jamming signal or an RF communication signal) to the front end 115 to be transmitted to the detected drone(s). The front end 115 can then process the signal received from the processor 111 before providing the processed signal to one or more of the transmit antennae 117A-117N.

There are a number of different techniques that the drone detection system 101 can use to detect the presence of the drones 103A-103N. For example, the drone detection system 101 can scan the airwaves at frequencies known to be used by particular model(s) of drones 103A-103N. If a known protocol is identified, the drone detection system 101 can then decode the signal as if it was the intended receiver/controller 105A-105N. Depending on the embodiment, these decoding steps can include: synchronization, channel estimation, de-interleaving, descrambling, demodulation, and error control decoding. In certain embodiments, the drone detection system 101 can be configured to perform some of the aforementioned steps blindly due to lack of knowledge (such as device id) on information known by the controller 105A-105N. As described below, the blind detection of the drones 103A-103N using certain communication protocols (e.g., a synchronization signal) are provided herein. Once detected, the drone detection system 101 can provide alert(s) regarding the presence of the one or more drones 103A-103N.

The drone detection system 101 can monitor the presence of the one or more drones 103A-103N. As part of monitoring, a position of the one or more drones 103A-103N relative to the environment 100 can be monitored in real-time to determine if the position of the one or more drones 103A-103N strays inside or outside acceptable airspace.

FIG. 2B illustrates an example drone 103 which can be detected with the drone detection system 101 in accordance with aspects of this disclosure. In certain embodiments, the drone 103 includes one or more propellers 121, one or more motor controllers 123, a battery or other power source 125, a memory 127, a processor 129, a front end 131, an antenna 133, and a camera 135. As described above, the antenna 133 may be configured to receive RF signals 107 from the controller 105 (see FIG. 2C) and provide RF signals 107 back to the controller 105 (e.g., images obtained from the camera 135). In certain embodiments, the RF signals 107 sent/received from the antenna 133 are provided to/from the processor 129 and processed by the front end 131. In certain embodiments, the propeller(s) 121 provides lift and controls movement of the drone 103 as it maneuvers through airspace. The propeller(s) 121 may also include one or more motor(s) (not illustrate) configured to individually power each of the propeller(s) 121.

In certain embodiments, the motor controller(s) 123 are configured to receive instructions from the processor 129 (e.g., based on instructions stored in the memory 127 and the RF signal 107 received from the controller 105) to move the drone 103 to a specific point in the airspace and translate the received instructions into motor position commands which are provided to the propeller(s) 121. In certain embodiments, the battery 125 provides power to each of the components of the drone 103 and has sufficient power storage to enable the propellers 121 to maneuver the drone 103 for a predetermined length of time. The camera 135 can capture images in real-time and provide the captured images to the controller 105 via the antenna 133 which can aid a user in controlling movement of the drone 103.

FIG. 2C illustrates an example controller 105 which can be used to control the drone 103 in accordance with aspects of this disclosure. In certain embodiments, the controller 105 comprises a memory 141, a processor 143, a front end 145, an antenna 147, an input device 149, and a display 151. As described above, the antenna 147 may be configured to receive RF signals 107 (e.g., images obtained from the camera 135) from the drone 103 (see FIG. 2B) and provide RF signals 107 back to the drone 103 to control movement of the drone 103. In certain embodiments, the RF signals 107 sent/received from the antenna 147 are provided to/from the processor 143 and processed by the front end 145. In certain embodiments, the input device 149 is configured to receive input from a user which can be used by the processor 143 to generate commands for controlling movement of the drone 103. In certain embodiments, the display 151 is configured to display images received from the drone 103 to the user to provide feedback on the current position of the drone 103 and its environment. In some embodiments, the display can be implemented as a pair of goggles worn by the user to provide a first-person view of images obtained by the camera 135.

### II. Description of Communication Systems

Modern communication systems routinely employ scramblers and error control code to form the transmit bit sequence. Scramblers help remove bias in the transmitted bit stream while error control codes add robustness to the transmission to mitigate channel variations and noise. Aspects of this disclosure relate to the class of scramblers known as synchronous scramblers using linear feedback shift registers (LFSR), and in particular, the broad class of linear error control codes. Most of the modern error control codes, such as block code, turbo code, Low-Density Parity-Check (LDPC), and polar codes are linear.

The use of unmanned aerial vehicles (UAV) has skyrocketed in recent years, with applications ranging from conventional aerial photography, agriculture, product delivery, infrastructure inspection, to hobbyist drone racing. As drones are expanding their productive uses, they are also becoming a leading security threat in airports, national borders, stadiums, and correctional facilities. The demand for airspace awareness in these sensitive locations is significant.

One step to accomplish this is to decode the scrambled bit sequence. While different devices share the same LFSR structure when generating their individual scrambling sequences, the scrambler starting state (for example, the scrambling seed) will be different to avoid devices from miscommunicating with each other. A spectrum scanner trying to detect the presence of these devices will have no prior knowledge about these individual scrambler seeds and can perform blind estimation for their values.

There are several works in the literature related to the problem addressed by this disclosure. For example, related problems with no noise in the system have been studied. The problem of reconstructing both the LFSR feedback polynomial and the initial state with noise has also been studied. This disclosure is different from these studies in that the problem to be solved includes the encoded bit stream and does not require estimating the feedback polynomial. Estimating feedback polynomial is more difficult than estimating the seed alone but may involve the use of a higher signal to noise ratio (SNR) to succeed. To detect devices from known manufacturers, one can determine the feedback polynomial by reverse engineering offline. Methods for solving a linear system of noisy linear GF(2) equations have been studied. This problem is related to the problem(s) solved by this disclosure once the solution is converted into a system of linear GF(2) equations.

### III. System Model

In some embodiments, an example transmitter can be configured to transmit a message m∈{0, 1}ⁿ^{ₘ} containing nₘ bits. m is then encoded by a linear error control code encoder G∈{0, 1}^{N×n}^{ₘ}. Most error control codes in modern communication systems are linear, including block code, turbo code, LDPC, and polar code. A linear scrambler using LFSR with nₛ registers can be used. The initial scrambler state is s∈{0, 1}ⁿ^{ₛ}^{×1} and the scrambler is represented by F∈{0, 1}^{N×n}^{ₛ}. The transmit bit vector x_{b} is given by:

$${x}_{b} = G m + F s , \qquad ( 1 )$$

where addition is performed under GF(2).

Each bit of x_{b} is transmitted using Binary Phase-Shift Keying (BPSK) to form transmit vector x∈ [symbol] ^{N×1} using the convention:

$$x [ k ] = \{ \begin{matrix}1 , if {x}_{b} [ k ] = 0 \\ - 1 , if {x}_{b} [ k ] = 1\end{matrix} , \qquad ( 2 )$$

Finally, the received vector y∈ [symbol] ^{N×1} is given by:

$$y = x + w , \qquad ( 3 )$$

where w∈ [symbol] ^{N×1} is the additive white Gaussian noise (AWGN) and w˜ [symbol] (0, σ²I).

The system can be configured to estimate the seed vector s using the received vector y. The seed vector s is desirable to obtain in its own right because the seed vector s usually serves as an excellent identifier for the individual device to be continuously tracked.

### IV. Techniques for Soft Initial Offset Estimation

From (3), the log likelihood ratio (LLR) of transmitted bit x[k] is:

$${λ}_{x [ k ]} = log \frac{P ( x [ k ] = 0 \vert y [ k ] )}{P ( x [ k ] = 1 \vert y [ k ] )} = \frac{y [ k ]}{{σ}^{2}} , \qquad ( 4 )$$

where the last equation is a solution for a BPSK signal. In some embodiments, the system can use implementation friendly operations, making the constant scaling term of σ² irrelevant, which can be dropped. Before describing the next step, the binary add operation for LLRs are described below.

$$\begin{matrix}{λ}_{u} ⊕ {λ}_{ν} = log \frac{P ( u ⊕ v = 0 )}{P ( u ⊕ v = 1 )} \\ = 2 {tanh}^{- 1} ( tanh ( \frac{{λ}_{u}}{2} ) tanh ( \frac{{λ}_{ν}}{2} ) )\end{matrix} \qquad \begin{matrix}( 5 ) \\ ( 6 )\end{matrix}$$

where the last operation will be approximated by the min-sum operation:

$${λ}_{u} ⊕ {λ}_{v} \approx sgn ( {λ}_{u} ) sgn ( {λ}_{v} ) {min}_{z = \{ u , v \}} \vert {λ}_{z} \vert , \qquad ( 7 )$$

where sgn(x) is the sign function defined by:

$$sgn ( x ) = \{ \begin{matrix}1 , & if x \geq 0 \\ - 1 , & if x < 0\end{matrix} , \qquad ( 8 )$$

Equation (7) can be extended to more terms:

$$\begin{matrix}{⊕}_{k = 1}^{N} {λ}_{{u}_{k}} {=}^{Δ} {λ}_{{u}_{1}} ⊕ {λ}_{{u}_{2}} ⊕ … ⊕ {λ}_{{u}_{N}} \\ = {\prod }_{k = 1}^{N} sgn ( {λ}_{{u}_{k}} ) {min}_{k = 1 , 2 , … , N} \vert {λ}_{{u}_{k}} \vert\end{matrix} \qquad \begin{matrix}( 9 ) \\ ( 10 )\end{matrix}$$

Next the impact of the error control code can be nulled out. First, the null space matrix H∈{0, 1}^{N×(N-n}^{ₘ}⁾ of the error control code matrix G that satisfies can be found:

$${H}^{T} G = 0 , \qquad ( 11 )$$

which can be found appending an identity matrix below G and carrying out the column reduced echelon form. Next a special matrix multiplication operation can be defined as follows:

$$A ⊗ B {=}^{Δ} C , \qquad ( 12 )$$

$$I ( A , r ) = \{ k : A [ r , k ] = 1 \} , \qquad ( 13 )$$

$$C [ {k}_{1} , {k}_{2} ] = {⊕}_{l ϵ I ( A , {k}_{1} )} B [ l , {k}_{2} ] , \qquad ( 14 )$$

where A∈{0, 1}^{l}^{₁}^{×l}^{₂}, B∈ [symbol] ^{l}^{₂}^{×l}^{₃}, C∈{0, 1}^{l}^{₁}^{×l}^{₃}.

Using the above, the error control code can be nulled out. Using null space matrix H on the right side of (1) yields:

$${H}^{T} {x}_{b} = {H}^{T} Gm + {H}^{T} Fs = {H}^{T} Fs , \qquad ( 15 )$$

By applying H_{T} on the left side of (3), the following system of equations results:

$${H}^{T} Fs = {H}^{T} ⊗ y , \qquad ( 16 )$$

Techniques for solving this system of equations have been developed. In aspects of this disclosure, the matrix is not broken into blocks and min-sum decoding is used on the resulting matrix. First, the parity matrix P of H^{T}F is determined, which is just its null space:

$${P}^{T} {H}^{T} F = 0 , \qquad ( 17 )$$

Then, min-sum decoding can be applied by using the parity matrix P. In some embodiments, the basic min-sum decoding technique can be used alone. The literature on decoding LDPC codes and polar codes offers a trove of enhancement techniques that can be leveraged.

### V. Simulations

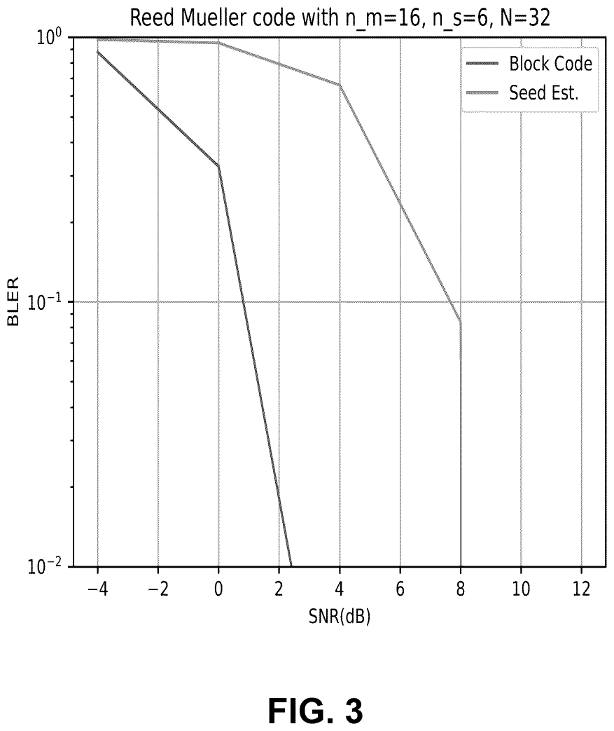

The performance aspects of this disclosure were studied using Monte Carlo simulations. FIG. 3 shows the decoding performance of the scrambler seed versus the underlying error control code in accordance with aspects of this disclosure. In the embodiment of FIG. 3, the error control code was a Reed Mueller Code.

### Implementing Systems and Terminology

Implementations disclosed herein provide systems, methods and apparatus for detecting the presence of drones. It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component via another component or directly connected to the second component.

The drone detection functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The previous description of the disclosed implementations is provided to enable any person skilled in the art to make or use the present invention. Various modifications to these implementations will be readily apparent to those skilled in the art, and the generic principles defined herein may be applied to other implementations without departing from the scope of the invention. For example, it will be appreciated that one of ordinary skill in the art will be able to employ a number corresponding alternative and equivalent structural details, such as equivalent ways of fastening, mounting, coupling, or engaging tool components, equivalent mechanisms for producing particular actuation motions, and equivalent mechanisms for delivering electrical energy. Thus, the present invention is not intended to be limited to the implementations shown herein but is to be accorded the widest scope consistent with the principles and novel features disclosed herein.

What is claimed is:

1. A method of estimating an initial state of a synchronous scrambler in the presence of a linear error control code, the method comprising:
receiving a vector including a transmit bit vector encoded using the linear error control code;
performing nulling on the linear error control code to null impact of the linear error control code from the received vector;
obtaining a system of equations from the received vector in response to performing the nulling on the linear error control code; and
using a min-sum procedure to recover the initial state of the synchronous scrambler from the system of equations.

2. The method of claim 1, wherein performing nulling on the linear error control code comprises:
obtaining a null space matrix of an error code control matrix by appending an identity matrix below the error code control matrix and carrying out a column reduced echelon form; and
nulling the error control code using a matrix multiplication operation.

3. The method of claim 2, wherein the matrix multiplication operation is defined as follows:
$$A ⊗ B {=}^{Δ} C , I ( A , r ) = \{ k : A [ r , k ] = 1 \} , C [ {k}_{1} , {k}_{2} ] = {⊕}_{l ϵ I ( A , {k}_{1} )} B [ l , {k}_{2} ] ,$$
where A∈{0, 1}^{l}^{₁}^{×l}^{₂}, B∈ [symbol] ^{l}^{₂}^{×l}^{₃}, C∈{0, 1}^{l}^{₁}^{×l}^{₃}.

4. The method of claim 2, wherein obtaining the system of equations comprises:
applying the null space matrix of the error code control matrix to the transmit bit vector.

5. The method of claim 1, further comprising:
obtaining a log likelihood ratio (LLR) of each of a plurality of transmit bits in the transmit bit vector; and
performing a binary add operation for the LLRs.

6. The method of claim 5, wherein performing the binary add operation for the LLRs comprises:
approximating the binary add operation using a min-sum operation.

7. The method of claim 6, wherein the min-sum operation is defined as:
$${λ}_{u} ⊕ {λ}_{ν} \approx sgn ( {λ}_{u} ) sgn ( {λ}_{ν} ) {min}_{z = \{ u , v \}} \vert {λ}_{z} \vert ,$$
where sgn(x) is a sign function defined by:
$$sgn ( x ) = \{ \begin{matrix}1 , & if x \geq 0 \\ - 1 , & if x < 0\end{matrix} .$$

8. The method of claim 1, further comprising:
mitigating a potential threat of a drone using the synchronous scrambler based on the initial state of the synchronous scrambler.

9. The method of claim 8, wherein mitigating the potential threat of the drone comprises:
transmitting a jamming radio frequency (RF) signal to disrupt communication between the drone and a controller, and/or spoofing the controller by sending a command to the drone to land or otherwise leave a current location.

10. A drone detection system, comprising:
a radio-frequency (RF) receiver configured to receive a vector transmitted as an RF signal using a synchronous scrambler in the presence of a linear error control code;
a processor; and
a computer-readable memory in communication with the processor and having stored thereon computer-executable instructions to cause the processor to:
receive the vector including a transmit bit vector encoded using the linear error control code;
perform nulling on the linear error control code to null impact of the linear error control code from the received vector;
obtain a system of equations from the received vector in response to performing the nulling on the linear error control code; and
use a min-sum procedure to recover an initial state of the synchronous scrambler from the system of equations.

11. The system of claim 10, wherein the processor is further caused to:
obtain a null space matrix of an error code control matrix by appending an identity matrix below the error code control matrix and carrying out a column reduced echelon form; and
null the error control code using a matrix multiplication operation.

12. The system of claim 11, wherein the matrix multiplication operation is defined as follows:
$$A ⊗ B {=}^{Δ} C , I ( A , r ) = \{ k : A [ r , k ] = 1 \} , C [ {k}_{1} , {k}_{2} ] = {⊕}_{l ϵ I ( A , {k}_{1} )} B [ l , {k}_{2} ] ,$$
where A∈{0, 1}^{l}^{₁}^{×l}^{₂}, B∈ [symbol] ^{l}^{₂}^{×l}^{₃}, C∈{0, 1}^{l}^{₁}^{×l}^{₃}.

13. The system of claim 11, wherein obtaining the system of equations comprises causing the processor to:
apply the null space matrix of the error code control matrix to the transmit bit vector.

14. The system of claim 10, wherein the processor is further caused to:
obtain a log likelihood ratio (LLR) of each of a plurality of transmit bits in the transmit bit vector; and
perform a binary add operation for the LLRs.

15. The system of claim 14, wherein to perform the binary add operation for the LLRs comprises causing the processor to:
approximate the binary add operation using a min-sum operation.

16. The system of claim 15, wherein the min-sum operation is defined as:
$${λ}_{u} ⊕ {λ}_{ν} \approx sgn ( {λ}_{u} ) sgn ( {λ}_{ν} ) {min}_{z = \{ u , v \}} \vert {λ}_{z} \vert ,$$
where sgn(x) is a sign function defined by:
$$sgn ( x ) = \{ \begin{matrix}1 , & if x \geq 0 \\ - 1 , & if x < 0\end{matrix} .$$

17. The system of claim 10, wherein the processor is further caused to:
mitigate a potential threat of a drone using the synchronous scrambler based on the initial state of the synchronous scrambler.

18. The system of claim 17, wherein mitigating the potential threat of the drone comprises causing the processor to:
transmit a jamming radio frequency (RF) signal to disrupt communication between the drone and a controller, and/or spoofing the controller by sending a command to the drone to land or otherwise leave a current location.

19. A non-transitory computer readable storage medium having stored thereon instructions that, when executed, cause a computing device to:
receive a vector including a transmit bit vector encoded a synchronous scrambler in the presence of a linear error control code;
perform nulling on the linear error control code to null impact of the linear error control code from the received vector;
obtain a system of equations from the received vector in response to performing the nulling on the linear error control code; and
use a min-sum procedure to recover an initial state of the synchronous scrambler from the system of equations.

20. The non-transitory computer readable storage medium of claim 19, further comprising:
obtain a null space matrix of an error code control matrix by appending an identity matrix below the error code control matrix and carrying out a column reduced echelon form; and
null the error control code using a matrix multiplication operation.
